(19) United States
(12) Patent Application Publication
(10) Pub. No.: US 2016/0365994 A1
(43) Pub. Date: Dec. 15, 2016

(54) FREQUENCY-MODULATED CARRIER RECEIVER USING INJECTION-LOCKED OSCILLATOR

(71) Applicant: Richtek Technology Corporation, Hsinchu (TW)

(72) Inventors: Sheng-Tsung CHEN, Hsinchu City (TW); Yen-Yin HUANG, Taoyuan City (TW); Ming-Shih YU, New Taipei City (TW)

(73) Assignee: RICHTEK TECHNOLOGY CORPORATION, Hsinchu (TW)

(21) Appl. No.: 14/735,672

(22) Filed: Jun. 10, 2015

(51) Int. Cl. H04L 27/14

(52) U.S. Cl. CPC H04L 27/14

(57) ABSTRACT

A frequency-modulated carrier receiver includes a signal extractor and an injection-locked oscillator. The signal extractor is configured to operably receive a frequency-modulated carrier and generate an injection signal based on the frequency-modulated carrier, so that the injection signal has a relatively smaller frequency variation than the frequency-modulated carrier. The injection-locked oscillator is coupled with the signal extractor and configured to operably filter out noise components in the injection signal to generate an output signal.

### BACKGROUND

The disclosure generally relates to a frequency-modulated carrier receiver and, more particularly, to a frequency-modulated carrier receiver using an injection-locked oscillator.

Band-pass filters are widely utilized in many frequency-modulated carrier receivers to filter out noises in the received carrier. Many conventional band-pass filters are implemented with passive components and thus need to occupy considerable area on the circuit board. In addition, some conventional band-pass filters are provided with additional compensation circuits to align the center frequency of the band-pass filter with the frequency of the received carrier. The use of compensation circuits not only occupies circuit board area, but also increases the circuitry complexity of the frequency-modulated carrier receiver.

### SUMMARY

An example embodiment of a frequency-modulated carrier receiver is disclosed, comprising: a signal extractor, configured to operably receive a frequency-modulated carrier and generate an injection signal based on the frequency-modulated carrier, so that the injection signal has a relatively smaller frequency variation than the frequency-modulated carrier; and an injection-locked oscillator, coupled with the signal extractor, configured to operably filter out noise components in the injection signal to generate an output signal.

Another example embodiment of a frequency-modulated carrier receiver is disclosed, comprising: an injection-locked oscillator, configured to operably receive a frequency-modulated carrier and filter out noise components from the frequency-modulated carrier to generate an output signal having same frequency as a target frequency signal in the frequency-modulated carrier.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of a frequency-modulated carrier receiver according to one embodiment of the present disclosure.

FIG. 2 shows a simplified functional block diagram of the signal extractor in FIG. 1 according to one embodiment of the present disclosure.

FIG. 3 shows a simplified functional block diagram of the signal extractor in FIG. 1 according to another embodiment of the present disclosure.

FIG. 4 shows a simplified functional block diagram of the signal extractor in FIG. 1 according to yet another embodiment of the present disclosure.

FIG. 5 shows a simplified functional block diagram of a frequency-modulated carrier receiver according to another embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

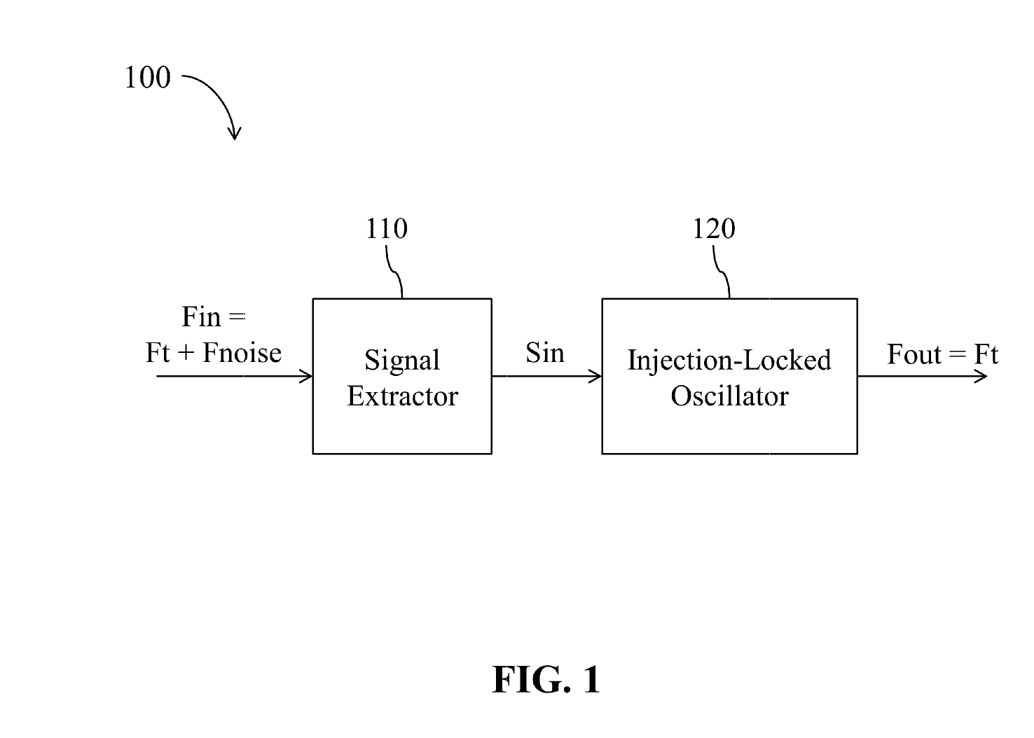

FIG. 1 shows a simplified functional block diagram of a frequency-modulated carrier receiver 100 according to one embodiment of the present disclosure. In this embodiment, the frequency-modulated carrier receiver 100 comprises a signal extractor 110 and an injection-locked oscillator 120.

In the frequency-modulated carrier receiver 100, the signal extractor 110 is configured to operably receive an incoming frequency-modulated carrier Fin, such as a FM carrier or a FSK carrier. In addition, the signal extractor 110 is also configured to operably generate an injection signal Sin based on the frequency-modulated carrier Fin, so that the injection signal Sin has a frequency close to the frequency-modulated carrier Fin while having a relatively smaller frequency variation than the frequency-modulated carrier Fin. In practice, depends upon the circuitry structure of the injection-locked oscillator 120, the injection signal Sin generated by the signal extractor 110 may be realized in the form of a single-ended signal or a pair of differential signals.

The injection-locked oscillator 120 is coupled with the signal extractor 110 and configured to operably filter out noise components from the injection signal Sin to generate an output signal Fout.

As shown in FIG. 1, the frequency-modulated carrier Fin received by the signal extractor 110 is typically composed of a target frequency signal Ft and a noise signal Fnoise. As is well known in the related art, the presence of the noise signal Fnoise often causes the frequency-modulated carrier Fin to have a greater frequency variation or an unstable DC level. That is, the noise signal Fnoise often causes the frequency variation of the frequency-modulated carrier Fin to be greater than the situation where there is no noise signal Fnoise in the frequency-modulated carrier Fin, and often causes the DC level of the frequency-modulated carrier Fin to vary from time to time.

The main functionality of the signal extractor 110 is to create an injection signal Sin having a frequency close to the frequency-modulated carrier Fin while having a relatively smaller frequency variation than the frequency-modulated carrier Fin, so that the center oscillating frequency of the injection-locked oscillator 120 can be easily locked to the frequency of the target frequency signal Ft. Several embodiments of the signal extractor 110 will be further described in the following.

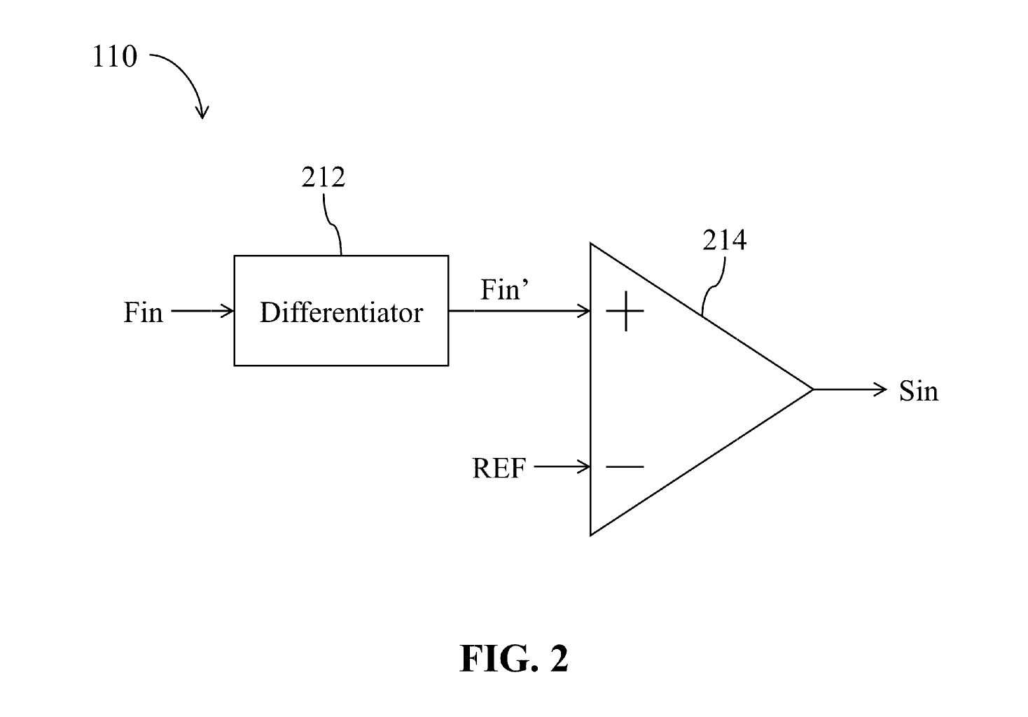

Please refer to FIG. 2, which shows a simplified functional block diagram of the signal extractor 110 in FIG. 1 according to one embodiment of the present disclosure.

In the embodiment of FIG. 2, the signal extractor 110 comprises a differentiator 212 and a comparison circuit 214. The differentiator 212 is configured to operably generate a differentiation signal Fin′ based on the frequency-modulated carrier Fin. The comparison circuit 214 is coupled with the differentiator 212 and configured to operably compare the differentiation signal Fin′ with a reference signal REF to generate a binary signal and utilize the binary signal to be the injection signal Sin.

In practice, a signal equal to or close to the DC output of the differentiator 212 may be employed as the reference signal REF of the comparison circuit 214. In this way, some low frequency noise components in the frequency-modulated carrier Fin would be cancelled by the cooperation of the differentiator 212 and the comparison circuit 214, and thus would not appear in the resulting injection signal Sin.

As a result, the injection signal Sin generated by the comparison circuit 214 would have a frequency close to the frequency-modulated carrier Fin while having a relatively smaller frequency variation than the frequency-modulated carrier Fin. In some embodiments where the injection signal Sin is a single-ended signal, the injection signal Sin may thus have a fixed DC level, which is relatively stable than the DC level of the frequency-modulated carrier Fin.

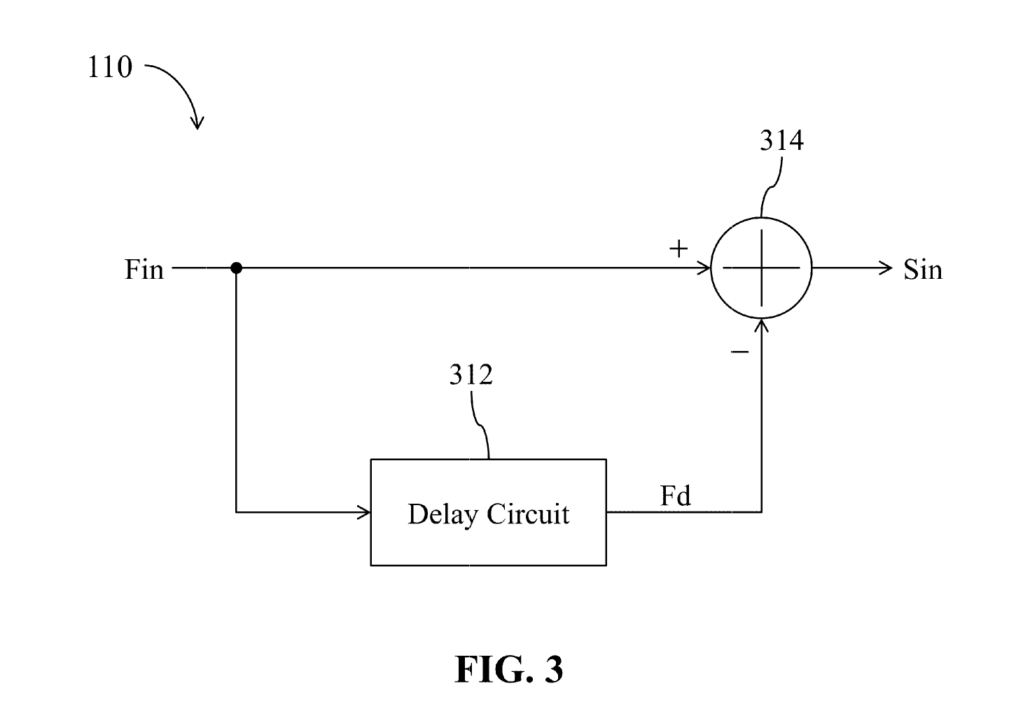

Please refer to FIG. 3, which shows a simplified functional block diagram of the signal extractor 110 in FIG. 1 according to another embodiment of the present disclosure.

In the embodiment of FIG. 3, the signal extractor 110 comprises a delay circuit 312 and a subtraction circuit 314. The delay circuit 312 is configured to operably generate a delayed signal Fd based on the frequency-modulated carrier Fin. The subtraction circuit 314 is coupled with the delay circuit 312 and configured to operably generate the injection signal Sin based on the frequency-modulated carrier Fin and the delayed signal Fd.

In practice, the delay circuit 312 may apply a predetermined delay to the frequency-modulated carrier Fin to generate the delayed signal Fd, and the subtraction circuit 314 may subtract the delayed signal Fd from the frequency-modulated carrier Fin to generate the injection signal Sin.

For example, the delay circuit 312 may delay the frequency-modulated carrier Fin by a half signal period of the frequency-modulated carrier Fin to generate the delayed signal Fd. In this way, some low frequency noise components in the frequency-modulated carrier Fin would be cancelled by the subtraction circuit 314, and thus would not appear in the resulting injection signal Sin.

As a result, the injection signal Sin generated by the subtraction circuit 314 would have a frequency close to the frequency-modulated carrier Fin while having a relatively smaller frequency variation than the frequency-modulated carrier Fin. In some embodiments where the injection signal Sin is a single-ended signal, the injection signal Sin may thus have a fixed DC level, which is relatively stable than the DC level of the frequency-modulated carrier Fin.

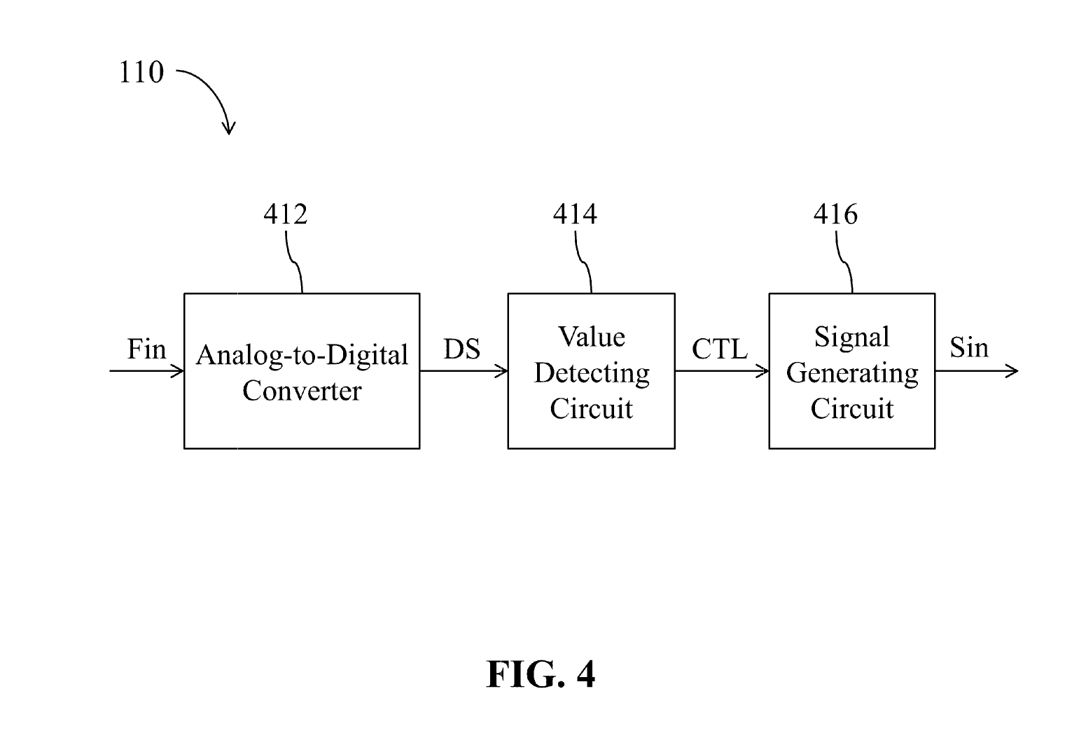

Please refer to FIG. 4, which shows a simplified functional block diagram of the signal extractor 100 in FIG. 1 according to yet another embodiment of the present disclosure.

In the embodiment of FIG. 4, the signal extractor 110 comprises an analog-to-digital converter 412, a value detecting circuit 414, and a signal generating circuit 416. The analog-to-digital converter 412 is configured to operably convert the frequency-modulated carrier Fin into a digital signal DS. The value detecting circuit 414 is coupled with the analog-to-digital converter 412 and configured to operably detect signal values of the digital signal DS to generate a control signal CTL for representing peak positions or valley positions of the frequency-modulated carrier Fin. The signal generating circuit 416 is coupled with the value detecting circuit 414 and configured to operably generate the injection signal Sin according to the control signal CTL.

In one embodiment, for example, when the value detecting circuit 414 detects that a signal value of the digital signal DS is greater than a peak threshold, the value detecting circuit 414 generates an active pulse in the control signal CTL to represent a peak position of the frequency-modulated carrier Fin.

In another embodiment, when the value detecting circuit 414 detects that a signal value of the digital signal DS is lower than a valley threshold, the value detecting circuit 414 generates an active pulse in the control signal CTL to represent a valley position of the frequency-modulated carrier Fin. In practice, the aforementioned valley threshold is typically small than the peak threshold.

It can be appreciated from the foregoing descriptions that the control signal CTL generated by the value detecting circuit 414 in the above embodiments has the same period of the frequency-modulated carrier Fin to a certain extent.

The signal generating circuit 416 may generate a clock signal having a relatively smaller frequency variation than the frequency-modulated carrier Fin while having the same period of the control signal CTL, and utilize the clock signal to be the injection signal Sin. As a result, the injection signal Sin generated by the signal generating circuit 416 would have a frequency close to the frequency-modulated carrier Fin while having a relatively smaller frequency variation than the frequency-modulated carrier Fin. In some embodiments where the injection signal Sin is a single-ended signal, the injection signal Sin may thus have a fixed DC level, which is relatively stable than the DC level of the frequency-modulated carrier Fin.

In operations, the injection-locked oscillator 120 generates the output signal Fout according to the injection signal Sin generated by the signal extractor 110. As described previously, the frequency variation of the injection signal Sin generated by the signal extractor 110 is relatively smaller than the frequency variation of the frequency-modulated carrier Fin. Accordingly, the center oscillating frequency of the injection-locked oscillator 120 could be easily locked to the frequency of the target frequency signal Ft, so as to render the output signal Fout to have the same frequency as the target frequency signal Ft.

As a result, it is apparent that the noise signal Fnoise in the frequency-modulated carrier Fin is effectively filtered out by the injection-locked oscillator 120. Accordingly, the injection-locked oscillator 120 provides high noise immunity to the frequency-modulated carrier receiver 100.

From another aspect, the injection-locked oscillator 120 realizes the functionality of a band-pass filter with an ultra-narrow bandwidth.

In practice, the injection-locked oscillator 120 may be implemented with various existing injection-locked oscillating circuits. For example, the injection-locked oscillator 120 may be implemented with various injection-locked ring oscillators or LC-tank injection-locked oscillators.

As described previously, depends upon the circuitry structure of the injection-locked oscillator 120, the injection signal Sin generated by the signal extractor 110 may be realized in the form of a single-ended signal or a pair of differential signals.

In the foregoing descriptions, the signal extractor 110 is utilized to operate with the injection-locked oscillator 120 to filter out the noise in the frequency-modulated carrier Fin. This is merely an exemplary embodiment, rather than a restriction to the practice implementations.

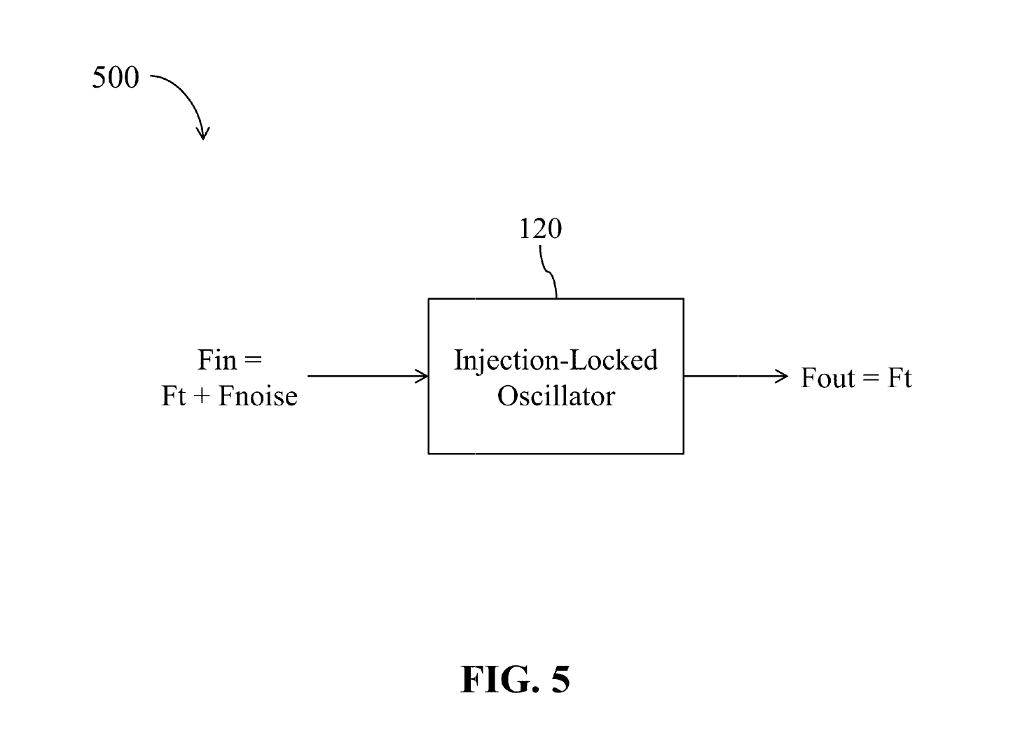

For example, FIG. 5 shows a simplified functional block diagram of a frequency-modulated carrier receiver 500 according to another embodiment of the present disclosure. The signal extractor 110 in the previous embodiments is omitted in the frequency-modulated carrier receiver 500.

In the frequency-modulated carrier receiver 500, the injection-locked oscillator 120 is configured to operably receive an incoming frequency-modulated carrier Fin and to operably filter out the noise signal Fnoise from the frequency-modulated carrier Fin to generate an output signal Fout having the same frequency as the target frequency signal Ft in the frequency-modulated carrier Fin. As a result, the noise signal Fnoise in the frequency-modulated carrier Fin is effectively filtered out by the injection-locked oscillator 120.

As can be appreciated from the foregoing elaborations, the injection-locked oscillator 120 provides high noise immunity to the frequency-modulated carrier receiver 100 or 500. The noise signal Fnoise in the frequency-modulated carrier Fin can be effectively filtered out by utilizing the injection-locked oscillator 120 or the combination of the signal extractor 110 and the injection-locked oscillator 120, without utilizing additional compensation circuits or complex calibration mechanism. A as result, the circuitry complexity of the frequency-modulated carrier receiver 100 or 500 can be effectively reduced in comparison with conventional art.

In addition, the architecture of the injection-locked oscillator 120 is much simpler than conventional band-pass filter, and thus it requires less circuit board area in implementing the frequency-modulated carrier receiver.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

1. A frequency-modulated carrier receiver (100), comprising:
a signal extractor (110), configured to operably receive a frequency-modulated carrier (Fin) and generate an injection signal (Sin) based on the frequency-modulated carrier (Fin), so that the injection signal (Sin) has a relatively smaller frequency variation than the frequency-modulated carrier (Fin); and
an injection-locked oscillator (120), coupled with the signal extractor (110), configured to operably conduct a band-pass filtering operation on the injection signal (Sin) to filter out noise components from the injection signal (Sin) to generate an output signal (Fout) having same frequency of a target frequency signal (Ft) in the frequency-modulated carrier (Fin).

2. The frequency-modulated carrier receiver (100) of claim 1, wherein the signal extractor (110) comprises:
a differentiator (212), configured to operably generate a differentiation signal (Fin′) based on the frequency-modulated carrier (Fin); and
a comparison circuit (214), coupled with the differentiator (212), configured to operably compare the differentiation signal (Fin′) with a reference signal (REF) to generate the injection signal (Sin).

3. The frequency-modulated carrier receiver (100) of claim 2, wherein the reference signal (REF) corresponds to a DC output of the differentiator (212).

4. The frequency modulated carrier receiver (100) of claim 1, A frequency-modulated carrier receiver (100), comprising:
a signal extractor (110), configured to operably receive a frequency-modulated carrier (Fin) and generate an injection signal (Sin) based on the frequency-modulated carrier (Fin), so that the injection signal (Sin) has a relatively smaller frequency variation than the frequency-modulated carrier (Fin); and
an injection-locked oscillator (120), coupled with the signal extractor (110), configured to operably filter out noise components from the injection signal (Sin) to generate an output signal (Fout) having same frequency of a target frequency signal (Ft) in the frequency-modulated carrier (Fin);
wherein the signal extractor (110) comprises:
a delay circuit (312), configured to operably generate a delayed signal (Fd) based on the frequency-modulated carrier (Fin); and
a subtraction circuit (314), coupled with the delay circuit (312), configured to operably generate the injection signal (Sin) based on the frequency-modulated carrier (Fin) and the delayed signal (Fd).

5. The frequency-modulated carrier receiver (100) of claim 4, wherein the delay circuit (312) delays the frequency-modulated carrier (Fin) by a half signal period of the frequency-modulated carrier (Fin) to generate the delayed signal (Fd).

6. A frequency-modulated carrier receiver (100), comprising:
a signal extractor (110), configured to operably receive a frequency-modulated carrier (Fin) and generate an injection signal (Sin) based on the frequency-modulated carrier (Fin), so that the injection signal (Sin) has a relatively smaller frequency variation than the frequency-modulated carrier (Fin); and
an injection-locked oscillator (120), coupled with the signal extractor (110), configured to operably filter out noise components from the injection signal (Sin) to generate an output signal (Fout) having same frequency of a target frequency signal (Ft) in the frequency-modulated carrier (Fin);
wherein the signal extractor (110) comprises:
an analog-to-digital converter (412), configured to operably convert the frequency-modulated carrier (Fin) into a digital signal (DS);
a value detecting circuit (414), coupled with the analog-to-digital converter (412), configured to operably detect signal values of the digital signal (DS) to generate a control signal (CTL) for representing peak positions or valley positions of the frequency-modulated carrier (Fin); and
a signal generating circuit (416), coupled with the value detecting circuit (414), configured to operably generate the injection signal (Sin) according to the control signal (CTL).

7. The frequency-modulated carrier receiver (100) of claim 6, wherein when the value detecting circuit (414) detects that a signal value of the digital signal (DS) is greater than a peak threshold, the value detecting circuit (414) generates an active pulse in the control signal (CTL) to represent a peak position of the frequency-modulated carrier (Fin).

8. The frequency-modulated carrier receiver (100) of claim 6, wherein when the value detecting circuit (414) detects that a signal value of the digital signal (DS) is lower than a valley threshold, the value detecting circuit (414) generates an active pulse in the control signal (CTL) to represent a valley position of the frequency-modulated carrier (Fin).

9. A frequency-modulated carrier receiver (500), comprising:
an injection-locked oscillator (120), configured to operably receive a frequency-modulated carrier (Fin) and to operably conduct a band-pass filtering operation on the frequency-modulated carrier (Fin) to filter out noise components from the frequency-modulated carrier (Fin) to generate an output signal (Fout) having same frequency as a target frequency signal (Ft) in the frequency-modulated carrier (Fin).
